(19) United States
(12) Patent Application Publication
(10) Pub. No.: US 2015/0067183 A1
(43) Pub. Date: Mar. 5, 2015

(54) WIRELESS TERMINAL HAVING FUNCTION FOR REDUCING NETWORK LOAD AND METHOD FOR REDUCING NETWORK LOAD THEREOF

(71) Applicant: IDEAWARE INC., Seongnam-si, Gyeonggi-do (KR)

(72) Inventor: Yang Meong Cha, Seongnam-si (KR)

(73) Assignee: IDEAWARE INC., Seongnam-si, Gyeonggi-do (KR)

(21) Appl. No.: 14/389,739

(22) PCT Filed: Apr. 18, 2013
(86) PCT No.: PCT/KR2013/003300

§ 371 Date: Sep. 30, 2014

(30) Foreign Application Priority Data
Apr. 25, 2012 (KR) 10-2012-0043432

(51) Int. Cl. H04W 76/02; H04L 29/08

(52) U.S. Cl. CPC H04W 76/027; H04L 67/14
USPC 709/228

(57) ABSTRACT

The present invention relates to a wireless terminal having a function for reducing network load and a method for reducing network load thereof. The wireless terminal includes a policy storage section for storing identification information of one or more applications allowed network usage irrespective of data limit into a storage region; a policy receiving section for receiving the policy information for blocking the network usage from a server over a communication network in case of exceeding the data limit; and a processing section for blocking network connection for all applications except the applications corresponding to the pre-stored identification information of the applications allowed network usage among the applications using networks based on the received policy information for blocking the network usage.

### BACKGROUND OF THE INVENTION

1. Technical Field

The present invention is to reduce wireless network load by automatically blocking network connection of the applications for wireless terminal exceeding data limit.

2. Description of the Related Art

After supplying smart-phones, patterns using wireless terminal for individuals are abruptly changed from voice communication to data communication.

In FIG. 1 shown as mobile (wireless) data traffic index, mobile traffics are expected to increase to 26 times in the next 10 to 15 years, and mobile data amount of 15 MB used by individuals per day has been used in 2010 but mobile data amount of 1 GB will be used in 2020.

The increase of the mobile traffics directly effects on profitability and service quality of the mobile-service company and accompanies a service provider, that is, a mobile-service company's equipment expansion, and therefore profit aggravation is inevitable and a user using a mobile network has service dissatisfaction due to data communication velocity delay.

Therefore, the mobile-service company must effectively use network infra to reduce investment burden and to guarantee service quality and an alternative guaranteeing predictability and real-time control is needed due to the limits of current solutions.

On the other hand, FIG. 2 shows that numerous applications at the wireless terminal exceeding data limit cause network connection traffics irrespective of exceeding of the data limit.

Particularly, in the situation such as FIG. 2, the applications installed in the wireless terminal endlessly request the network connection traffics to receive data to be wanted because the wireless terminal may not receive data on connecting to application servers even on attempting the network connection on the condition exceeding the data limit already, and the network connection request causes overload in the communication network.

In order to solve much cost consumption of the mobile communication company due to network jam and service dissatisfaction for users of the wireless terminal, a method for blocking periodic network usage by a plurality of applications installed in the wireless terminal is absolutely needed, but there is no a solution for this.

### SUMMARY OF THE INVENTION

An object of the present invention for solving the above-mentioned problems is that it provides a wireless terminal having network load reducing function and network load reduction method thereof capable of controlling unnecessary network connection trial itself performed by the applications installed in the wireless terminal that may not connect to application servers and receive data even on attempting the network connection on the condition exceeding the data limit already, and improving data communication environment of the user and reducing battery consumption by network jam removal while reducing network expansion cost of a mobile communication company and improving service quality by the controlling by storing identification information of applications allowed network usage irrespective of data limit into a storage region by policy agent installed in wireless terminal, receiving the policy information blocking the network usage from a server on a communication network in case of exceeding the data limit, blocking network connection attempts for all applications except the applications corresponding to identification information of applications allowed the network usage pre-stored in the storage region, of the applications using network based on the received policy information blocking the network usage, and releasing network connection blocking for the applications based on the received policy information for releasing the network usage blocking on receiving the policy information for releasing the network usage blocking from a server on a communication network in case of restoring the data limit.

Another object of the present invention for solving the above-mentioned problems is that it provides a wireless terminal having network load reducing function and network load reduction method thereof capable of releasing the network connection blocking of the applications installed in the wireless terminal without communicating with a server by blocking the network connection for all applications except the applications corresponding to the identification information of the applications allowed the network usage pre-stored in the storage region, of the applications using network based on the policy information for blocking the network usage, checking the current day and time and checking restoration day and time information of data limit after exceeding the data limit, and releasing network connection blocking for the applications, in the case that the current day and time is corresponded to the restoration day and time of the data limit, after the checking.

Technical tasks to achieve in the present invention are not limited to the above-mentioned technical tasks. Other technical tasks which are not mentioned may be clearly understandable for those who skilled in the art of the present invention from the following description.

According to an aspect of the invention, there is provided a wireless terminal having function for reducing network load. The wireless terminal includes a policy storage section for storing identification information of applications allowed network usage irrespective of data limit into a storage region; a policy receiving section for receiving the policy information for blocking the network usage from a server on a communication network in case of exceeding data limit; and a processing section for blocking network connection for all applications except the applications corresponding to the identification information of one or more applications for which network usage is allowed, the identification information being pre-stored in the storage region, among the applications using network, based on the policy information for blocking the network usage received by the policy receiving section.

According to the aspect of the invention, the policy receiving section further receives the policy information for releasing network usage blocking from a server on a communication network in case of restoring the data limit and the processing section releases network connection blocking for the applications based on the policy information for releasing the network usage blocking received by the policy receiving section.

According to another aspect of the invention, the wireless terminal having function for reducing network load further includes a checking section for checking the current day and time information and for checking restoration day and time of the data limit after exceeding the data limit, wherein the processing section releases the network connection blocking for the applications, when the current day and time is the restoration day and time of the data limit, after the checking.

There is provided a method for reducing a network load in the wireless terminal according to an embodiment of the present invention. The Method includes storing identification information of applications for which network usage is allowed irrespective of data limit into a storage region by using a policy agent installed in the wireless terminal; receiving the policy information for blocking the network usage from a server on a communication network by using the policy agent installed in the wireless terminal in case of exceeding the data limit; blocking network connection for all applications except the applications corresponding to the identification information of applications for which network usage is allowed, the identification information being pre-stored in the storage region, of the applications using network based on the received policy information blocking the network usage by the policy agent installed in the wireless terminal; and releasing network connection blocking for the applications based on the received policy information releasing the network usage blocking by the policy agent installed in the wireless terminal on receiving policy information for releasing the network usage blocking from a server on a communication network in case of restoring the data limit.

And, there is provided a method for reducing a network load in the wireless terminal according to another embodiment of the present invention. The method includes storing identification information of applications for which network usage is allowed irrespective of data limit into a storage region by policy agent installed in wireless terminal; receiving the policy information for blocking the network usage from the server on the communication network by the policy agent installed in the wireless terminal in case of exceeding the data limit; blocking network connection for all applications except the applications corresponding to the identification information of applications for which network usage is allowed, the identification information being pre-stored in the storage region, of the applications using network based on the received policy information blocking the network usage by the policy agent installed in the wireless terminal; checking the current day and time information and checking restoration day and time of data limit after exceeding the data limit by the policy agent installed in the wireless terminal; and releasing the network connection blocking for the applications by the policy agent installed in the wireless terminal, when the current day and time is the restoration day and time of the data limit, after the checking.

Further, the present invention includes a computer-readable recording medium for recording programs to execute each step.

Further, the policy information for blocking network usage includes the policy information for blocking network connection for the all applications except pre-designated specific applications among the applications using network installed in the wireless terminal.

According to an embodiment of the present invention, the present invention may block unnecessary network connection attempts itself performed by the applications installed in the wireless terminal that may not receive data after connecting to the application servers even on attempting the network connection on the condition exceeding the data limit already.

According to another embodiment of the present invention, the present invention may block unnecessary network connection attempts itself performed by the applications installed in the wireless terminal, thereby to optimize network usage at wireless terminal stages.

According to further another embodiment of the present invention, mobile-service company's network expansion cost may be minimized by optimizing the network usage.

According to further yet another embodiment of the present invention, on optimizing network usage, it is possible to minimize dissatisfaction for the wireless terminal's user caused by data communication delay, etc. and to greatly reduce battery consumption for the wireless terminal.

### BRIEF DESCRIPTION OF THE DRAWINGS

The following drawing drawings attached to the present specification illustrate an exemplary embodiment of the invention, and serves to further understand the technical idea of the invention along with a detailed description of the invention. Therefore, the invention is not limited to matters described in the drawings.

FIG. 1 shows mobile (wireless) data traffic indexes.

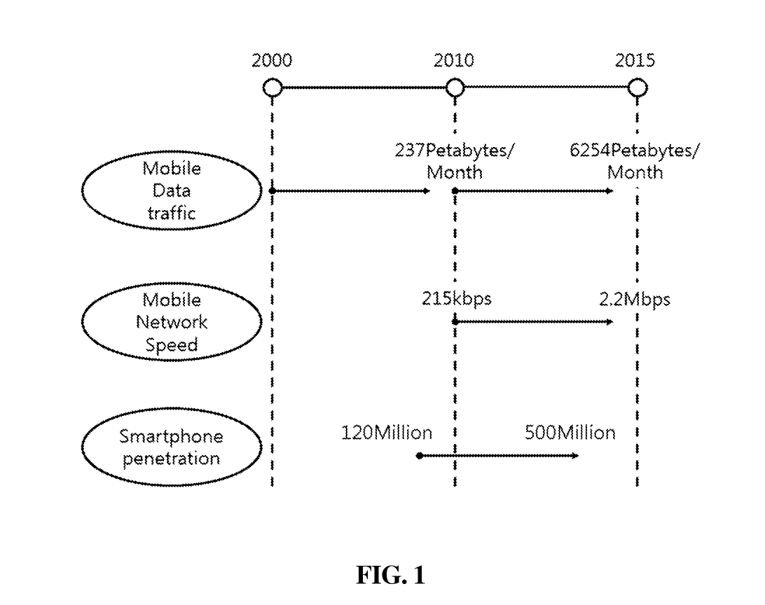

FIG. 2 shows main factors that may cause prior mobile network jam.

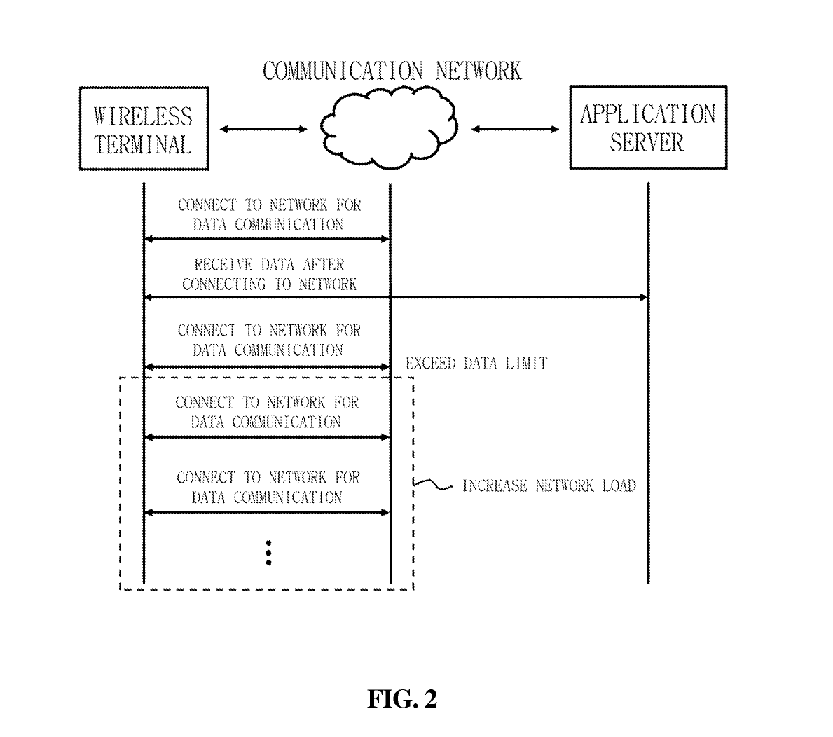

FIG. 3 shows communication network or network connection according to an embodiment of the present invention.

FIG. 4 shows sub-configurations for a wireless terminal according to the embodiment of the present invention.

FIG. 5 is one embodiment showing effects blocking network connection of the wireless terminal exceeding data limit according to an embodiment of the present invention.

FIG. 6 shows a process blocking network connection of wireless terminal that exceed the data limit according to the embodiment of the present invention.

FIG. 7 shows a process releasing network connection blocking of the wireless terminal restoring the data limit according to the embodiment of the present invention.

FIG. 8 shows a process releasing network connection blocking of the wireless terminal restoring the data limit according to another embodiment of the present invention.

### DESCRIPTION OF THE PREFERRED EMBODIMENTS

Hereinafter, referring to enclosed figures and descriptions, operation principles of preferred embodiments of the present invention will be described. However, figures illustrated and descriptions mentioned in the below are only for the preferred embodiments among various method of describing features of the present invention. Therefore, the present invention is not limited to the figures illustrated and descriptions mentioned in the below. Additionally, in case of determining that a detailed description about known function or structure relating to the present invention may evade the main point of the present invention, the detailed description may be omitted. Also, terms to be mentioned in the following are defined in consideration of functions in the present invention, which may be vary according to the intention of a user or an operator, practical customs, etc. Therefore, the definition of the terms shall be made based on the overall contents of the present invention.

In conclusion, the technical spirit of the present invention shall be decided by claims. The following embodiments are merely a means for describing progressive spirit of the present invention to persons who skilled in the art of the present invention.

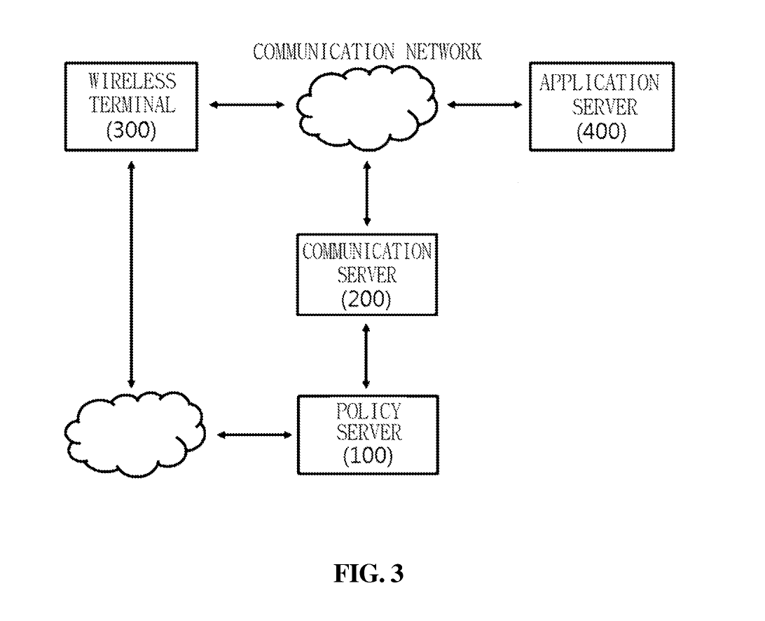

FIG. 3 shows a communication network or network connection according to an embodiment of the present invention.

In more detail, FIG. 3 shows configurations that an user's wireless terminal 300 are connected to a policy server 100 and a communication server 200 through the communication networks to control network connection of applications for the wireless terminal 300 exceeding the data limit.

The policy server 100 according to the present invention checks identification information of policy agent installed in the wireless terminal 300 in response to identification information of the user's wireless terminal 300 exceeding the data limit through a storage medium 130 connecting and storing identification information of the wireless terminal 300 and identification information of policy agent installed in the wireless terminal 300, and transmits policy information for blocking network usage to policy agent corresponding to the identification information of the checked policy agent, on receiving identification information of the user's wireless terminal 300 exceeding the data limit from a communication server 200 on a communication network.

The policy information for blocking the network usage includes the policy information for blocking network connection for the remaining all applications, except for pre-populated specific applications, of a plurality of applications installed in the wireless terminal 300.

According to the present invention, the policy server 100 receives the identification information of the wireless terminal 300 whose data limit is restored from the communication server 200 on the communication network, checks the identification information of the policy agent installed in the wireless terminal 300 in response to the received identification information of the wireless terminal 300 through the storage medium 130, transmits policy information for releasing network usage blocking to the policy agent corresponding to the checked identification information of the policy agent, and transmits the identification information of the applications for which network usage is allowed to the policy agent irrespective of exceeding of data limit.

The communication server 200 according to an embodiment of the present invention relays data communication between the wireless terminal 300 and an application server, checks whether the wireless terminal 300 exceeds the data limit, and transmits the identification information of the wireless terminal 300 exceeding the data limit to the policy server 100 in case of exceeding the data limit after the checking.

According to the present invention, the communication server 200 checks exceeding of the data limit by an intelligence network, and then checks causes of exceeding the data limit by a subscriber information server (a server for storing and managing IMEI information, information of a subscriber's terminal, subscription/cancellation information for a rate system, etc. of the wireless terminal 300).

Further, the communication server 200 checks restoration or not of the data limit for the wireless terminal 300 exceeding the data limit by a subscriber information server, and then transmits the identification information of the wireless terminal 300 whose data limit is restored to the policy server 100 in case of restoring the data limit after the checking.

The subscriber information server may be included in the communication server 200.

The wireless terminal 300 according to an embodiment of the present invention performs network connection to the application server, and autonomously controls the network connection (or background call connection, etc.) of a plurality of applications installed in the wireless terminal 300 by the policy information, for blocking the network usage, and the policy information, for releasing the network usage blocking, received from the policy server 100.

Also, the wireless terminal 300 in advance stores the identification information of the applications for which network usage is allowed irrespective of limit of data into a storage region 330, and excludes the applications corresponding to the identification information of the applications allowed the network usage, pre-stored in the storage region 330, among the applications using networks on performing the policy information, for blocking the network usage, received from the policy server 100 according to exceeding of the data limit.

The wireless terminal 300 blocks the network connection for the remaining all applications, except for the applications corresponding to the identification information of one or more applications allowed the network usage, the identification information being pre-stored in the storage region 330, among the applications using networks, based on the policy information for blocking the network usage. Afterwards, the wireless terminal 300 checks the current day and time information and checks restoration day and time of the data limit after exceeding the data limit, releases network connection blocking for the applications in the case that the current day and time is corresponded to the restoration day and time of the data limit after the checking, and autonomously releases the network connection blocking of the applications installed in the wireless terminal 300 without communicating with a server.

According to the present invention, the wireless terminal 300 include all terminal, capable of wirelessly communicating, such as a mobile phone, a smart-phone, a tablet PC, etc.

The application server 400 according to the present invention transmits and receives data on performing network connection for the applications installed in the user's wireless terminal 300.

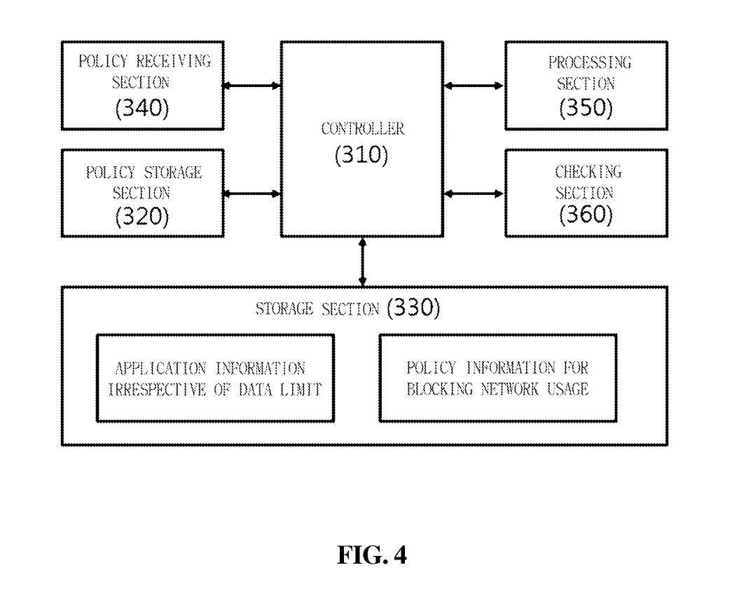

FIG. 4 shows sub-configurations of the wireless terminal 300 according to an embodiment of the present invention.

In more detail, FIG. 4 shows sub-configurations for the wireless terminal 300 shown in FIG. 3, each configuration is to describe an embodiment of the present invention, and the present invention is not limited to the embodiment only shown in FIG. 4.

Referring to FIG. 4, the wireless terminal 300 in the embodiment of the present invention includes a policy receiving section 340, a policy storage section 320, a policy storage region 330, a processing section 350, a checking section 360, and a controller 310 for controlling each configuration.

Wholly or in part of each configuration of the wireless terminal 300 may be configured in a program type such as policy agent.

Referring to FIG. 4, the policy receiving section 340 receives identification information of the applications allowed the network usage irrespective of the data limit from the policy server 100, and receives various information such as the policy information, for blocking the network usage, and the policy information, for releasing the network usage blocking, from the policy server 100.

The policy storage region 320 according to the embodiment of the present invention stores the identification information of one or more applications allowed the network usage irrespective of the data limit into the storage region 330, the identification information being received by the policy receiving section 340.

According to the present invention, the policy storage region 320 further stores the policy information for blocking the network usage and the policy information for releasing the network usage blocking, besides the identification information of the applications allowed the network usage irrespective of the data limit, into the storage region 330.

The storage region 330 stores and manages the identification information of the applications allowed the network usage irrespective of the data limit.

Further, the storage region 330 stores the policy information for blocking the network usage and the policy information for releasing the network usage blocking, besides the identification information of the applications allowed the network usage irrespective of the data limit.

The processing section 350 according to the embodiment of the present invention blocks the network connection for all applications except the applications corresponding to the identification information of the applications allowed the network usage, the identification information being pre-stored in the storage region 330, among the applications using network based on the policy information for blocking the network usage.

Further, in case of receiving policy information for releasing the network usage blocking from the policy server 100 over the communication network by using the policy receiving section 340, the processing section 350 releases the network connection blocking for the applications based on the policy information for releasing the network usage blocking.

The checking section 360 according to an embodiment of the present invention checks the current day and time information and checks restoration day and time of the data limit after exceeding the data limit.

That is, when the data limit is re-assigned at a first day of the month, the checking section 360 checks whether it become the day and time for data restoration by checking whether the current day and time become 12 am on the first day of each month and.

The processing section 350 in the present invention releases the network connection blocking for the applications installed in the wireless terminal 300, in the case that the current day and time is corresponded to the restoration day and time of the data limit, according to the result checked by the checking section 360.

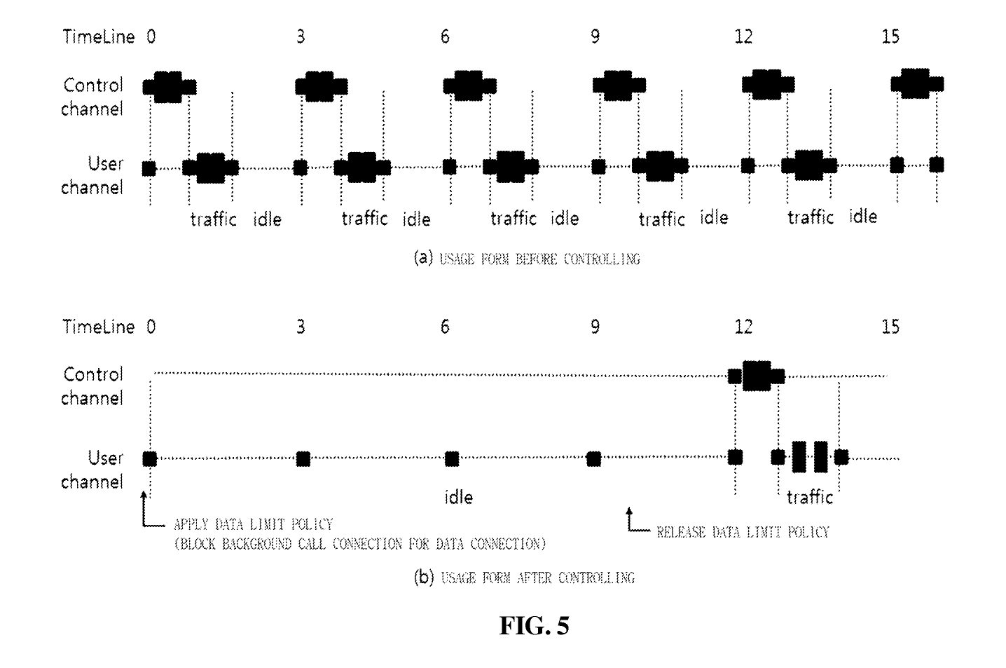

FIG. 5 is one embodiment showing effects generated by network connection blocking of wireless terminal 300 exceeding the data limit according to an embodiment of the present invention.

Referring to FIG. 5, a traffic reduction effect at the wireless terminal 300 before and after applying the policy is shown on performing the policy information (policy information, etc. for blocking background call connection for various applications) for blocking the network connection and releasing the network connection blocking to various applications installed in the wireless terminal 300 exceeding the data limit by the policy agent installed in the wireless terminal 300.

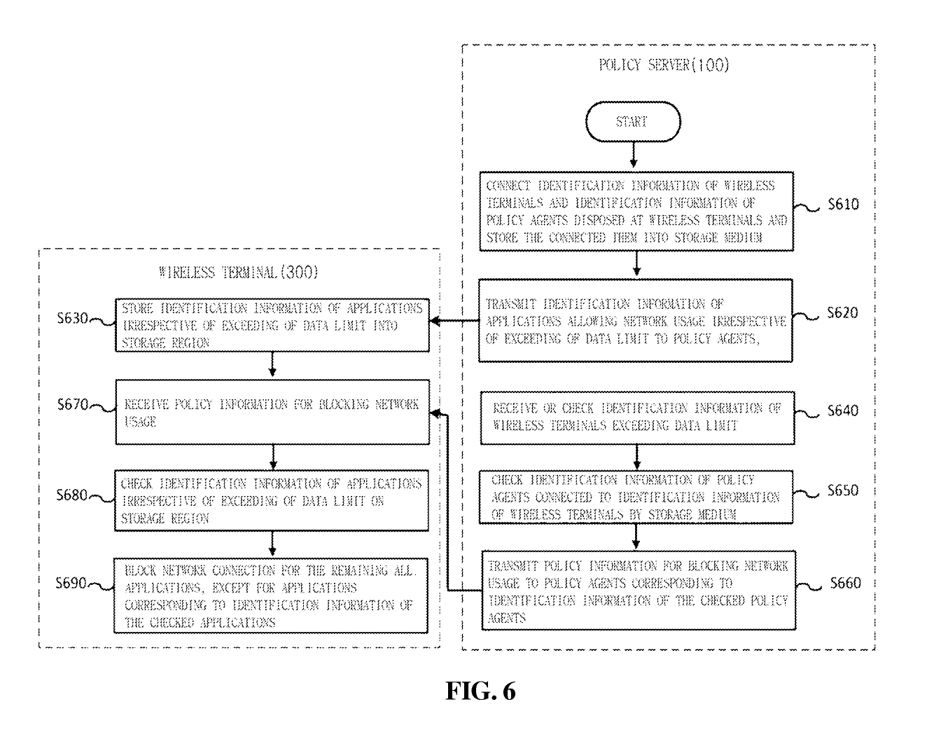

FIG. 6 shows a process for blocking the network connection for the wireless terminal 300 exceeding the data limit according to an embodiment of the present invention.

Firstly, the policy server 100 connects the identification information of a plurality of the wireless terminal 300 and the identification information of each policy agent installed in the plurality of wireless terminal 300 and therefore stores the connected them into the storage medium (S610).

Then, the policy server 100 transmits the identification information of the applications allowed the network usage irrespective of the exceeding of the data limit to the policy agent installed in the wireless terminal 300, and stores the identification information of the applications allowed the network usage irrespective of the exceeding of data limit into the storage region 330 by the policy agent (S620).

Orders for the steps S610 and S620 may be changed.

The wireless terminal 300 receive the identification information of the applications allowed the network usage irrespective of the data limit transmitted by the policy server 100 and therefore stores the received information into the storage region 330 (S630).

The policy server 100 receives the identification information of the user's wireless terminal 300 exceeding the data limit from the communication server 200, or directly checks the identification information of the user's wireless terminal 300 exceeding the data limit (S640).

In step S640, the communication server 200 determines whether the wireless terminal 300 exceed the data limit on relaying data communication between the wireless terminal 300 and the application server 400 at the communication network or on the network, and transmits the identification information of the wireless terminal 300 exceeding the data limit to the policy server 100, in the case that the wireless terminal 300 requesting the network connection exceed the data limit, after the determining.

The policy server 100 checks the identification information of the policy agent installed in the wireless terminal 300, the identification information of the policy agent corresponding to the received or checked identification information of the wireless terminal 300 exceeding the data limit by using the storage medium (S650).

Then, the policy server 100 transmits the policy information for blocking the network usage to the policy agent corresponding to the checked identification information of the policy agent (S660).

The policy agent of the wireless terminal 300 receive the policy information for blocking the network usage from the policy server 100 (S670), and checks the applications corresponding to the identification information of the applications allowed the network usage, pre-stored in the storage region 330, among a plurality of applications (S680).

Then, the policy agent of the wireless terminal 300 block the network connection for all applications except the applications corresponding to the identification information of the applications allowed the network usage pre-stored in the storage region 330, of a plurality of applications using networks based on the policy information for blocking the received network usage (S690).

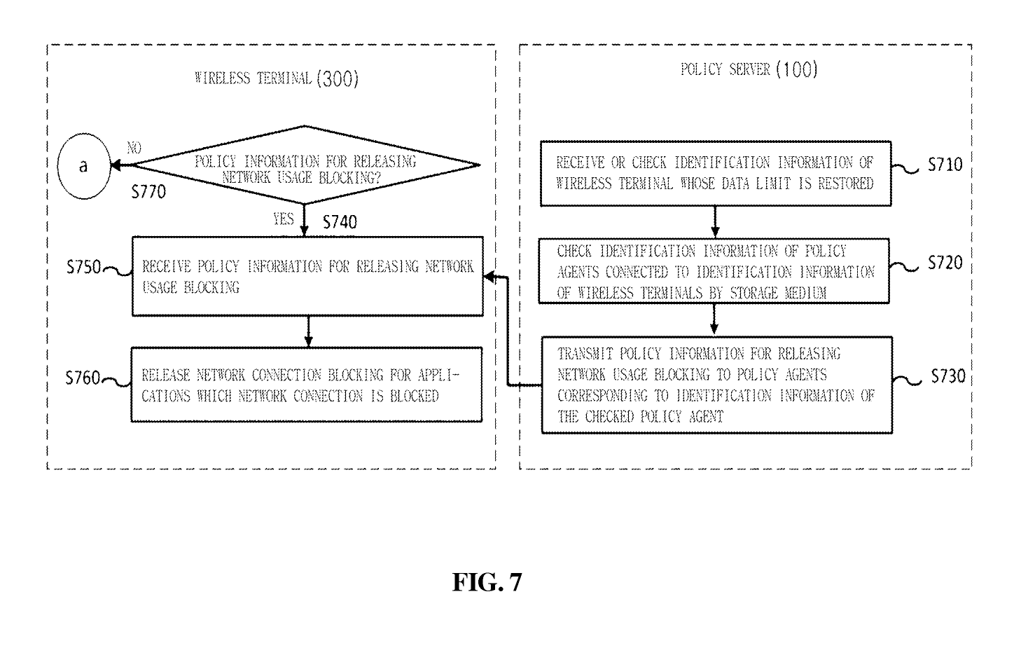

FIG. 7 shows a process releasing the network connection blocking for the wireless terminal 300 whose data limit is restored, according to an embodiment of the present invention.

The policy server 100 in the present invention receives or directly checks the identification information of the user's wireless terminal 300 whose data limit is restored from the communication server (S710).

In step S710, whether the data limit for the wireless terminal 300 exceeding the data limit is restored may be checked in the communication server 200 or the policy server 100 by checking a restoration period of the data limit for the wireless terminal 300 or information requesting data restoration due to additively paying data fee by a subscriber of the wireless terminal 300

The policy server 100 checks the identification information of the policy agent installed in the wireless terminal 300 in response to the identification information of the user's wireless terminal 300 restoring the received or checked data limit by the storage medium (S720).

Then, the policy server 100 transmits the policy information for releasing the network usage blocking to the policy agent corresponding to the identification information of the checked policy agent (S730).

The policy agent installed in the wireless terminal 300, in case of releasing the network usage blocking by the policy information for releasing the network usage blocking (S740), receives the policy information for releasing the network usage blocking transmitted from the policy server 100 (S750), and releases the network connection blocking for the applications based on the received policy information for releasing the network usage blocking (S760).

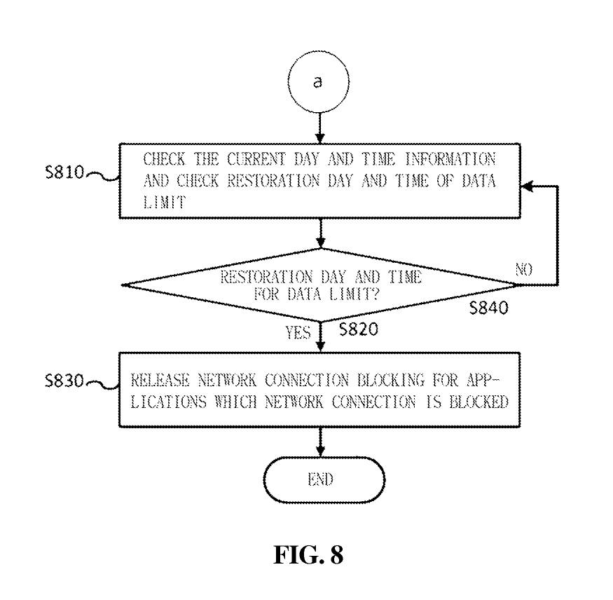

A process in which the policy agent installed in the wireless terminal 300 autonomously releases the network usage blocking (S770), not using the policy information for releasing the network usage blocking, is described in FIG. 8.

FIG. 8 shows a process releasing network connection blocking for wireless terminal 300 whose data limit is restored according to another embodiment of the present invention.

The policy agent of the wireless terminal 300 checks the current day and time information by using a timer, etc. in the wireless terminal 300, in case of autonomously releasing the networking usage blocking (S810).

In case the current day and time information is the restoration day and time for the data limit in the step of S810 (S820), the policy agent releases the network connection blocking for the applications blocked the network connection due to the exceeding of the data limit (S830).

When the current day and time information is not the restoration day and time for the data limit in the step of S810 (S840), the policy agent of the wireless terminal 300 repeats the step S810.

1-6. (canceled)

7. A wireless terminal having a function for reducing network load, comprising:
a policy receiving section for receiving policy information for blocking network usage from a server over a communication network in case of exceeding the data limit; and
a processing section for blocking network connection for all applications except one or more applications allowed network usage, among a plurality of applications installed in the wireless terminal, according to the received policy information for blocking the network usage.

8. The wireless terminal having a function for reducing network load according to claim 7, wherein the policy information for blocking the network usage blocks attempt call for network connection of the applications.

9. The wireless terminal having a function for reducing network load according to claim 7, wherein the policy information for blocking the network usage blocks background connection of the applications.

10. The wireless terminal having a function for reducing network load according to claim 7, wherein the applications allowed the network usage are preset to be allowed the network usage irrespective of data limit for the wireless terminal's user.

11. The wireless terminal having a function for reducing network load according to claim 7, wherein identification information of the application allowed the network usage is received from the server and stored in the wireless terminal of a subscriber to a rate system with data limit.

12. The wireless terminal having a function for reducing network load according to claim 11, further comprising:
a policy storage section for storing the identification information of the application allowed the network usage and the policy information for blocking the network usage.

13. The wireless terminal having a function for reducing network load according to claim 7, wherein the wireless terminal is equipped with a policy agent receiving the policy information for blocking the network usage and blocking the network usage of the applications according to the received policy information.

14. The wireless terminal having a function for reducing network load according to claim 7, wherein the network connection of the applications is controlled according to subscription or cancellation information of a rate system with data limit for the wireless terminal's user.

15. The wireless terminal having network load reducing function according to claim 7, further comprising a checking section for checking information of the current day and time and checking whether the data limit of the wireless terminal is restored.

16. The wireless terminal having network load reducing function according to claim 15, wherein the processing section releases the network connection blocking for the applications, in case the data limit is restored.

17. A method for reducing network load in a wireless terminal, comprising:
receiving policy information for blocking network usage from a server over a communication network in case of exceeding data limit; and
blocking network connection for all applications except one or more application allowed network usage, among a plurality of applications installed in the wireless terminal, according to the received policy information for blocking the network usage.

18. The method for reducing network load in the wireless terminal according to claim 17, wherein the policy information for blocking the network usage is for blocking attempt calls for network connection of the applications.

19. The method for reducing network load in the wireless terminal according to claim 17, wherein the policy information for blocking the network usage blocks background connection of the applications.

20. The method for reducing network load in the wireless terminal according to claim 17, wherein the received policy information blocking the network usage is stored together with identification information of the application allowed the network usage.

21. The method for reducing network load in the wireless terminal according to claim 17, wherein the wireless terminal is equipped with a policy agent for receiving the policy information for blocking the network usage and blocking network connection of the applications according to the received policy information.

22. The method for reducing network load in the wireless terminal according to claim 17, wherein the policy information for blocking the network usage is transmitted to the wireless terminal from the server by using identification information of the wireless terminal,
The identification information of the wireless terminal includes subscription information of the wireless terminal's user or identification information of a policy agent equipped in the wireless terminal.

23. The method for reducing network load in the wireless terminal according to claim 17, wherein the network connection for the application is controlled according to subscription or cancellation information of a rate system with data limit for the wireless terminal's user.

24. The method for reducing network load in the wireless terminal according to claim 17, further comprising:
checking the current day and time information and checking whether data limit is restored after exceeding the data limit.

25. The method for reducing network load in the wireless terminal according to claim 24, further comprising releasing the network connection blocking for the applications, in case that the data limit is restored, according to a result of the checking.

26. A computer-readable recording medium for recording programs to perform a method of claim 17.
